(19) United States
(12) Patent Application Publication
(10) Pub. No.: US 2025/0293620 A1
(43) Pub. Date: Sep. 18, 2025

(54) AMYLOID FIBER-BASED ELECTRICITY GENERATOR

(71) Applicants: COMMISSARIAT A L'ENERGIE ATOMIQUE ET AUX ENERGIES ALTERNATIVES, Paris (FR); UNIVERSITE GRENOBLE ALPES, Saint-Martin-D'Heres (FR); CENTRE NATIONAL DE LA RECHERCHE SCIENTIFIQUE, Paris (FR)

(72) Inventors: Vincent FORGE, Grenoble (FR); Joffrey CHAMPAVERT, Grenoble (FR); Julien HURTAUD, Grenoble (FR); Patrice RANNOU, Saint Martin D'Heres (FR)

(21) Appl. No.: 18/860,222

(22) PCT Filed: May 3, 2023
(86) PCT No.: PCT/EP2023/061720

§ 371 Date: Oct. 25, 2024

(30) Foreign Application Priority Data
May 3, 2022 (FR) FR2204201

(51) Int. Cl. H02N 11/00

(52) U.S. Cl. CPC H02N 11/002

(57) ABSTRACT

The use of hydronium ion-conducting amyloid fibers or of wires comprising a plurality of hydronium ion-conducting amyloid fibers for generating electrical energy from a humid surrounding atmosphere. The invention also relates to a device comprising such fibers or wires.

### TECHNICAL FIELD

The present invention relates to the generation of electrical power. More precisely, the invention discloses a device comprising amyloid wires for generating electrical power from ambient humidity or any atmosphere containing water vapor, and also to the use thereof for generating energy and the process for preparing same.

### PRIOR ART

The demand for power, notably electrical power, is ever-increasing, and renewable energy sources are becoming a necessity in order to reduce the negative environmental impact of fossil fuel consumption. Water, which covers 71% of the Earth's surface, represents the world's largest energy tank. Water captures about 35% of the solar energy received by the Earth, corresponding to 60 petawatts (10¹⁵ W) (Stephens et al., Nature Geosci. 5, 691-696 (2012)).

Considerable efforts have been made to recover energy from water in its various forms: rivers and oceans, tides and even raindrops. The recovery of energy from water-hydroelectricity-is achieved mainly through the construction of hydraulic dams and tidal power plants. These plants mainly use electromagnetic generators, which are heavy, bulky and dependent on the available water supply.

Very recently, hydrovoltaics has been proposed as an alternative means of generating electrical power from water (Zhang et al., Nature Nanotech. 13, 1109-1119 (2018)). Unlike current technologies that recover kinetic energy (in the case of streams and rivers) or potential energy (in the case of ponds and lakes) from water, hydrovoltaic technology allows energy to be generated directly from the direct interaction between water and material. However, the hydrovoltaics developed to date mainly use inorganic materials. The materials currently in use are produced from silicon nanowires, Ni/Al hydroxide or even carbon (graphene or carbon nanotubes) (Yang et al. (2018) J. Am. Chem. Soc. 140, 13746-13752; Tang et al., (2016), Angew. Chem. Int. Ed. 55, 14412-14416; Yin et al. (2014), Nat. Commun. 5, 3582; Xu et al., Nature 578, 392-396 (2020)).

Water in the form of vapor in the ambient atmosphere could also be used for energy recovery.

Energy production from ambient humidity has been reported with biological materials (Liu et al., Nature 578, 550-554 (2020); WO 2020/069523).

However, this device, composed of bionanowires derived from Geobacter sulfurreducens, must be exposed to a water vapor gradient to produce energy. These filaments do not result from self-assembly, but require the bacterium's internal machinery for their formation. Furthermore, the bionanowires used are derived from a recombinant protein requiring the use of Escherichia coli as a support for their production; this is a major barrier to mass production and large-scale industrialization of the process.

Rongier (2018, thesis entitled “Protein self-assembly for bioelectronics: Study of charge transport in amyloid fibers”, submitted to public viva scrutiny on Feb. 13, 2018) describes an intrinsic charge transport process in amyloid fibers composed of HET-s (218-289) proteins, in which water channels formed within the fibers would allow proton transport via a Grotthuss-type mechanism. Said document does not, however, describe that such amyloid fibers are capable of generating electrical power when placed in a humid atmosphere.

There is a need for a low-cost material that can be easily obtained, notably on an industrial scale, to generate electrical power from a humid surrounding atmosphere.

There is also a need for such a material to be biodegradable and renewable.

There is also a need for such a material that allows the production of an amount of electrical power that can be modulated according to the relative humidity content in the surrounding atmosphere.

There is also a need for such a material that allows different electrical configurations to be produced.

There is also a need for a material that is capable of powering various items of electrical or electronic apparatus by generating electrical power from a humid surrounding atmosphere.

The object of the present invention is to meet all or some of these needs.

### DESCRIPTION OF THE INVENTION

The invention relates to a material comprising amyloid fibers which conduct hydronium ions and allow the potential energy source constituted by the humid surrounding atmosphere to be exploited to generate electrical power. The invention also relates to a device comprising such a material and configured to produce electrical power, and also to the use of at least one amyloid fiber or at least one such material, as described herein, to generate electrical power from water vapor, i.e. by contact of at least a portion of the fiber with a humid surrounding atmosphere. The material described herein is composed of proteins hierarchically self-assembled into amyloid fibers. These fibers may be assembled into wires. When inserted between two electrodes, this material, consisting of or composed of amyloid fibers, allows electrical power to be generated from the moisture of the surrounding atmosphere.

Advantageously, such a material is totally biodegradable and renewable. Such a material thus allows the production of low-cost green energy that can be modulated as a function of the ambient humidity content.

According to another of its advantages, an amyloid fiber material can be obtained inexpensively, for example from α-lactalbumin (α-La), which is a byproduct of dairy products and can be obtained on an industrial scale.

Advantageously, an amyloid fiber material has the advantage over inorganic materials of being biodegradable, nontoxic and biocompatible.

According to another of its advantages, an amyloid fiber material affords a potential difference at ambient humidity (60%) and very high humidity, thus allowing the voltage obtained to be adjusted and modulated to a target value.

According to another of its advantages, an amyloid fiber material can have a high internal resistance (˜100 MΩ (megaohms)). In an electrical power generation device comprising amyloid fiber wires, the resistance can be custom-modulated by varying the number of wires that can be placed in series or in parallel.

According to another of its advantages, an amyloid fiber material may be highly stable.

### SUMMARY OF THE INVENTION

The present invention relates to the use of at least one amyloid fiber, or at least one wire comprising a plurality of amyloid fibers, to generate electrical power from a humid surrounding atmosphere.

The term “fiber” is intended to denote a structure whose longitudinal dimension is significantly greater than its lateral dimension. The term “wire” is intended to denote an assembly of fibers.

The term “amyloid fiber” is intended to denote a fiber comprising proteins structured in β (beta) sheets and organizing into an insoluble fiber. The fiber may consist entirely of proteins structured in β (beta) sheets, or may consist essentially of proteins structured in β (beta) sheets, i.e. in amounts sufficient to give the fiber the properties of an amyloid fiber.

For the purposes of the invention, the expression “generating electrical power from a humid surrounding atmosphere” is intended to denote the ability of an amyloid fiber as described herein to react with at least part of the water vapor, or moisture, contained in the surrounding atmosphere, i.e. in contact with, and generate electrical power. The water vapor content of such an atmosphere is sufficient to allow the generation of hydronium ions. Hydronium ions can circulate along the amyloid fiber. A sufficient water vapor content may range from about 30% to about 100%.

The term “electrical power” is intended to denote the potential energy of an electric charge in an electric field or an electric current in a magnetic field. The electrical power generated when an amyloid fiber or amyloid fiber wire is used according to the invention is a potential difference created between the ends of the fiber or wire. This potential difference can be used to generate an electric current.

According to one of its aspects, the present invention relates to the use of at least one hydronium ion-conducting amyloid fiber, or at least one wire comprising a plurality of hydronium ion-conducting amyloid fibers, for generating electrical power from a humid surrounding atmosphere.

The term “hydronium ion” is intended to denote the HO₃⁺ cation resulting from the protonation of a water molecule.

The term “hydronium ion-conducting” fiber is intended to denote a fiber's ability to provide ion and proton type conduction, allowing hydronium ions or protons to move in its longitudinal direction.

As detailed in the examples section, the inventors have observed, surprisingly, that amyloid fibers exposed to a humid atmosphere are capable of generating an electric potential difference between its two ends. Specifically, it was observed that a wire composed of amyloid fibers, notably α-lactalbumin, obtained by forming and drying a hydrogel generated, for example, by heating α-lactalbumin proteins at acidic pH, inserted between two electrodes and exposed to a humid atmosphere, was capable of generating a potential difference and thus of producing electrical power. The electrical power thus produced allowed a capacitor to be fed and charged.

The experiments were performed in a surrounding atmosphere having a relative humidity (RH) of 95%. Such a relative humidity allows the generation of an electrical signal in a fast and readily available manner. Nevertheless, it is possible to operate a device as described herein at a lower humidity (40%).

According to one embodiment, a fiber or wire, as described herein, may be electrically connected to a first and a second electrode.

According to another of its aspects, the present invention relates to an electrical power generation device comprising:
a) at least one hydronium ion-conducting amyloid fiber, or at least one wire comprising a plurality of hydronium ion-conducting amyloid fibers,
b) at least one electrode pair comprising a first electrode and a second electrode, said electrodes being electrically connected to said fiber or wire,
said fiber or wire being intended to, or configured to, be exposed, at least partially, to a humid surrounding atmosphere.

The term “humid surrounding atmosphere” is intended to denote an atmosphere in contact with all or part of an amyloid fiber or a wire composed of amyloid fibers and comprising water molecules in the vapor state. The water vapor content of such an atmosphere is sufficient to allow the generation and conduction of hydronium ions in these fibers or wires. A sufficient water vapor content may range from about 0.1% to about 100%, for example from about 1% to about 99%, for example from about 2% to about 98%, for example from about 5% to about 95%, for example from about 10% to about 90%, for example from about 20% to about 80%, for example from about 30% to about 70%, for example from about 40% to about 60%.

The electrode pair (or the electrodes) of a device as described herein is configured to be connected to an electrical or electronic apparatus intended (or configured) to be supplied with electrical power.

As an implementation variant, a device as described herein may comprise a plurality of pairs of first and second electrodes, each of said electrode pairs being electrically connected to one wire or a plurality, at least 2, 3, 4, 5, 6, 7, 8, 9, 10, 20, 30, 40, 50, 60, 70, 80, 90, 100, 200, 500, 1000, or more, of wires. When an electrode pair is connected to a plurality of wires, these are electrically connected in parallel.

A device as described herein may comprise a plurality of pairs of first and second electrodes. These electrode pairs may be electrically connected to each other in series or in parallel.

According to an implementation variant, a use or device, as described herein, may include an amyloid fiber composed of proteins chosen from α-lactalbumin, β-lactoglobulin, lysozyme, or HET-s protein.

The amyloid fibers and wires described herein consist of self-assembled proteins structured in β sheets.

According to an implementation variant, a use or device as described herein may include a wire with a diameter from about 300 μm to about 700 μm, in particular about 500 82 m.

According to an implementation variant, a use or device as described herein may use a wire having a length from about 0.5 mm to about 2.5 mm, in particular from about 1.0 mm to about 1.5 mm.

According to an implementation variant, a use or device as described herein may use a first and a second electrode, the first and/or second electrode being a gold, silver, platinum, aluminum or carbon electrode.

According to another of its aspects, the present invention relates to the use of a device, as described herein, to supply electrical power to an electrical or electronic apparatus intended, or configured, to be supplied with electrical power.

According to another of its aspects, the present invention relates to a process for supplying electrical power to an electrical or electronic apparatus intended, or configured, to be supplied with electrical power, the process comprising at least one step consisting in exposing to a humid surrounding atmosphere, at least partially, at least one hydronium ion-conducting amyloid fiber, or at least one wire of such fibers, said fiber or wire being arranged in an electrical power-generating device as described herein, said device being electrically connected to said electrical apparatus.

According to another of its aspects, the present invention relates to a process for supplying electrical power to an electrical or electronic apparatus intended, or configured, to be supplied with electrical power, the process comprising at least the steps consisting in:
a) electrically connecting a device, as described herein, to an electrical or electronic apparatus intended to be fed with electrical power, and
b) exposing, at least partially, said fiber or said wire to a humid surrounding atmosphere.

According to another of its aspects, the present invention relates to a process for manufacturing a device, as described herein, comprising at least the steps consisting in:
a) contacting a hydrogel of amyloid fibers with an electrode pair comprising a first and a second electrode to electrically connect said electrodes with the hydrogel, and
b) drying the hydrogel to obtain a wire of amyloid fibers electrically connected to said electrodes.

The term “hydrogel of amyloid fibers” is intended to denote a three-dimensional network of protein chains structured in β (beta) sheets and containing water.

According to another of its aspects, the present invention relates to a process for manufacturing a device, as described herein, comprising at least the step of drying a hydrogel of amyloid fibers placed in contact with a first and a second electrode of an electrode pair to obtain a wire of amyloid fibers electrically connected to said electrodes.

According to another of its aspects, the present invention relates to a process for manufacturing a device, as described herein, comprising at least the steps consisting in:
contacting a hydrogel of amyloid fibers with a first and a second electrode of an electrode pair to electrically connect said electrodes with the hydrogel, and
drying the hydrogel of amyloid fibers to obtain an amyloid fiber wire electrically connected to said electrodes.

According to another of its aspects, the present invention relates to a process for manufacturing a device, as described herein, comprising at least the steps consisting in:
preparing a hydrogel of amyloid fibers by dissolving proteins that are capable of self-assembling into amyloid fibers, in a content ranging from at least 5 g/L to the solubility limit, in an acidic saline solution with a pH ranging from about 1.5 to about 2.5, and then heating the solution obtained at a temperature ranging from about 35 to 55° C., for a period of at least 10 hours,
contacting the hydrogel of amyloid fibers prepared in step a) with a first and a second electrode of an electrode pair to electrically connect said electrodes with the hydrogel, and
drying the hydrogel to obtain an amyloid fiber wire electrically connected to said electrodes.

According to another of its aspects, the present invention relates to an electrical or electronic apparatus supplied with electrical power by a device as described herein.

According to another of its aspects, the present invention relates to a moisture sensor comprising at least one device, as described herein.

According to another of its aspects, the present invention relates to a moisture-reactive electrical circuit breaker comprising at least one device, as described herein.

According to another of its aspects, the present invention relates to an electric charger comprising at least one device, as described herein.

These subjects, features and advantages, and also other aspects of the present invention, will be presented in detail in the description that follows.

### BRIEF DESCRIPTION OF THE DRAWINGS

FIG. 1 represents a scheme for producing α-lactalbumin amyloid wires configured for energy recovery from ambient humidity. α-Lactalbumin amyloid wires (6) are arranged between, and connected to, two platinum wires (1a,b). The platinum wires are connected to screws (5) allowing connection to an electrical circuit, and are arranged in glass capillaries (2). The end of each glass capillary (2) facing the α-lactalbumin wires (6) is sealed with beeswax (4). The α-lactalbumin amyloid wires (6) are obtained from a drop of α-lactalbumin amyloid fiber gel (3) placed between the platinum wires (1a,b) and left to dry for 1 to 3 hours (A).

FIG. 2 represents parallel (2A) and series (2B) circuit layouts in which each of the Gi-Zi represents a device comprising amyloid wires connected to platinum electrodes, as described herein.

FIG. 3 represents the electronic characterization of α-lactalbumin amyloid wires. (3A) represents the open-circuit potential differences (E_{oc} (V)) obtained as a function of the wire configuration: single wire (solid black), three wires in series (dashed black) and three wires in parallel (dotted black). (3B): 470 μF 16 V capacitor charge as a function of the wire configuration: single wire (solid black), three wires in series (dashed black) and three wires in parallel (dotted black). (3C): Charge of a 470 μF 16 V capacitor with three wires in parallel, and determination of the time constant. (3D): Stability of the capacitor charge over a period of 50 h.

FIG. 4 represents the evolution of the open-circuit potential (E(V)) on two α-lactalbumin amyloid wires as a function of humidity: at 95% and 60%, and the influence of the direction of connection to the electrodes, demonstrating polarization of the amyloid wires of α-lactalbumin proteins.

FIG. 5 represents (5A) a scheme for mounting a plate on which electrodes (5B) (7a, 7b) have been printed. The electrodes bear wax (8) at their ends. A drop of a hydrogel of amyloid fibers is deposited and left to dry (E).

### DETAILED DESCRIPTION

### Protein Amyloid Fibers and Wires

The present disclosure relates to the use of at least one amyloid fiber, or at least one wire comprising a plurality of amyloid fibers, for generating electrical power from a humid surrounding atmosphere.

The present disclosure relates to the use of at least one hydronium ion-conducting amyloid fiber, or at least one wire comprising a plurality of hydronium ion-conducting amyloid fibers, for generating electrical power from a humid surrounding atmosphere.

Many proteins are capable of self-assembling into amyloid fibers. Certain proteins assembled into amyloid fibers are toxic and are involved in pathological processes in humans, such as the β-amyloid peptide (beta-amyloid) implicated in Alzheimer's disease, or α-synuclein involved in Parkinson's disease.

For example, the proteins that are capable of self-assembling into amyloid fibers and implemented in the invention are nontoxic proteins. A “non-toxic protein” is a protein that is not involved in a pathological process in humans or animals. Non-toxic proteins that are capable of self-assembling into amyloid fibers are known in the field (Jackson et al., Biomolecules. 2017; 7(4): 71; Lee et al., Sci. Rep. 10, 5120 (2020); Roberts (2016) PLoS Biol. 14(1)).

Proteins that are suitable for use in the invention are proteins that are capable of forming, or self-assembling into, hydronium ion-conducting amyloid fibers.

As examples of proteins that may be used in the present description, mention may be made of α-lactalbumin,β-lactoglobulin, lysozyme, or the HET-s protein derived from the filamentous fungus Podospora anserina, and notably the HET-s(218-289) domain.

According to one embodiment, a protein that is capable of self-assembling into amyloid fibers is not the HET-s protein from the filamentous fungus Podospora anserina, or its HET-s(218-289) domain.

Proteins that are suitable for the invention may be obtained via any method known in the field, such as extraction from a biological source naturally expressing this protein or in the form of recombinant proteins obtained by heterologous expression in a host cell, for instance Escherichia coli or CHO cells, and amplification of the host cell in a bio-incubator. The recombinant proteins thus obtained are then purified via any method known in the field.

According to one embodiment, a protein that is suitable for use in the invention is α-lactalbumin.

α-Lactalbumin is a byproduct of dairy products, which is produced on an industrial scale in the cheese industry and may be obtained at low cost. This protein is present in whey.

α-Lactalbumin may be extracted as a monomer from whey. It is present in cow's milk at a level of 1.2 g/L. Alternatively, it may be produced in the form of a recombinant protein.

Amyloid fibers are very stable fibrillar nanostructures formed by the self-assembly of proteins organizing into β-sheets. The mechanisms of amyloid fiber formation follow a nucleation-elongation process. Thus, a protein acquires a secondary structure rich in β-strands which combine via hydrogen bonds to form β-sheets. Protein subunits self-assemble in successive stacks perpendicular to the fiber's elongation axis. The structure is stabilized by a dense network of H-bonds having an orientation parallel to the fibrillar axis.

The formation of amyloid fibers may depend on various parameters such as pH, ionic strength of the buffer, protein concentration, presence of other molecules, temperature or stirring speed, which may lead to different fibrillation kinetics and organizing. It falls to a person skilled in the art to adapt the operating conditions according to the nature of the proteins used.

Amyloid fibers may be obtained in the form of a hydrogel of protein fibers prepared as described in WO 2012/136909.

A hydrogel of amyloid fibers, notably α-lactalbumin, can be prepared using an aqueous solution comprising at least about 5 g/L of protein. The protein concentration in an aqueous solution may range from about 5 g/L to the solubility limit of the protein in the solution. For example, the protein concentration in the solution may range from about 10 g/L to about 60 g/L, from about 20 g/L to about 50 g/L, and may be, for example, about 40 g/L. The concentration of a protein in a solution intended for preparing a hydrogel of amyloid fibers may be about 5, 6, 7, 8, 9, 10, 11, 12, 13, 14, 15, 20, 22, 24, 26, 28, 30, 35, 40, 45, 50, 55, or about 60 g/L.

According to one embodiment, an aqueous solution of α-lactalbumin intended for preparing a hydrogel of amyloid fibers may comprise about 40 g/L of protein.

According to one embodiment, an aqueous solution of proteins intended for preparing a hydrogel of amyloid fibers may be a saline solution. An aqueous solution suitable for the present disclosure may have an ionic strength of less than or equal to about 60 mM, for example less than about 50 mM, or even about 30 mM.

The ionic strength of an aqueous solution of proteins used for preparing a hydrogel of amyloid fibers may range from about 0 mM to about 60 mM, for instance from about 20 mM to about 50 mM, and for example may be about 30 mM. The ionic strength of an aqueous solution of proteins used for preparing a hydrogel of amyloid fibers may be about 0, 1, 2, 3, 4, 5, 6, 7, 8, 9, 10, 12, 14, 16, 18, 20, 25, 30, 35, 40, 45, 50, 55, or about 60 mM.

The ionic strength can be obtained and/or adjusted by adding a salt which may be chosen from alkali metal or alkaline-earth metal halides, for instance NaCl, KCl, MgCl₂, CaCl₂, etc.; alkali metal or alkaline-earth metal carbonates or mixtures thereof; phosphates, for instance sodium or potassium phosphate, or even sulfates, for instance sodium or magnesium sulfate.

According to one embodiment, the ionic strength of an aqueous solution of proteins used for preparing a hydrogel of amyloid fibers, for example an aqueous solution of α-lactalbumin, may be adjusted by adding NaCl.

According to one embodiment, the ionic strength of an aqueous solution of proteins used for preparing a hydrogel of amyloid fibers, for example an aqueous solution of α-lactalbumin, may be about 30 mM.

The pH of an aqueous solution of proteins used for preparing a hydrogel of amyloid fibers may be an acidic pH. For example, the pH may be less than 3. For example, the pH of an aqueous solution of proteins used for preparing a hydrogel of amyloid fibers may range from about 1.0 to about 2.9, for example from about 1.5 to about 2.5, or even from about 1.8 to about 2.2, or even may be about 2.0. The pH of an aqueous solution of proteins used for preparing a hydrogel of amyloid fibers may be about 1.0, 1.1, 1.2, 1.3, 1.4, 1.5, 1.6, 1.7, 1.8, 1.9, 2.0, 2.2, 2.4, 2.6, 2.8, 3.0, 3.2 or about 3.5. The pH of an aqueous solution of proteins used for preparing a hydrogel of amyloid fibers may be about 1.5, 1.6, 1.7, 1.8, 1.9, 2.0, 2.1, 2.2, 2.3, 2.4, or about 2.5. The pH of an aqueous solution of proteins used for preparing a hydrogel of amyloid fibers may be less than 2.5. The acidic pH of the aqueous solution may be adjusted by means of a strong acid, for example HCl.

According to one embodiment, an aqueous solution of proteins used for preparing a hydrogel of amyloid fibers, for example of α-lactalbumin, may have a pH of about 2.0.

The acidic pH of the aqueous solution is adjusted before the protein is added and dissolved.

The preparation of an aqueous solution of proteins used for preparing a hydrogel of amyloid fibers may comprise a stirring step. Such a stirring step may be performed by stirring, by means of any device known in the art.

The preparation of an aqueous solution of proteins used for preparing a hydrogel of amyloid fibers may comprise a heating step, for example at a temperature ranging from about 35°° C. to about 55° C.

The heating step and the stirring step may be performed simultaneously.

The preparation of an aqueous solution of proteins used for preparing a hydrogel of amyloid fibers may comprise a filtration step. The filtration step may be performed prior to the heating step.

An aqueous solution of proteins used for preparing a hydrogel of amyloid fibers, of acidic pH, for example below 2.5, and ionic strength below 60 mM, may be subjected to a heating step, with stirring.

Prior to the heating step, the aqueous solution of proteins used for preparing a hydrogel of amyloid fibers may be filtered. The filtration may be performed, for example, with a 0.5 μm or 0.22 μm filter to purify the solution and remove any contaminants.

The heating step is performed at a temperature allowing the structuring of proteins in acidic aqueous solution into β sheets. The heating step is performed at a temperature below 60° C. For example, the heating temperature may be in a range varying from about 35° C. to about 55° C., and for example may be about 45° C. The heating step may be performed at a temperature of about 35, 36, 37, 38, 39, 40, 41, 42,,43, 44, 45, 46, 47, 48, 49, 50, 55, or 60° C.

The heating step may last at least 10 hours, or even a week (or 168 hours). For example, the heating step may last from 48 h to 96 h. The heating step may last from about at least 10 to about at least 168 h, from about at least 15 h to at least 150 h, from about at least 20 h to at least 125 h, from about at least 25 h to at least 115h, from about at least 30 h to at least 105 h, from about at least 40 h to at least 100 h, or even from about at least 48h to at least 96 h.

The heating step is performed with stirring. Stirring that is suitable for the present disclosure may have an intensity defined by a Reynolds number in a range varying from 37 to about 1000, for example from about 40 to about 950, from about 60 to about 900, from about 80 to about 850, from about 100 to about 800, from about 200 to about 600, or even from about 300 to about 500.

According to one embodiment, a process for preparing a hydrogel of amyloid fibers may comprise at least the steps consisting in: dissolving proteins that are capable of self-assembly into amyloid fibers, in a content ranging from at least 5 g/L to the solubility limit, in an acidic saline solution with a pH ranging from about 1.5 to 2.5, then heating the resulting solution at a temperature ranging from about 35 to 55° C., for a period of at least 10 hours.

For example, a process for preparing a hydrogel comprising protein fibers may comprise at least the steps consisting in:
dissolving in an acidic solution a protein that is capable of self-assembly into amyloid fibers at a concentration ranging from about 5 g/L to about the solubility limit, the acidic solution having a pH below about 2.5 and an ionic strength below 60 mM,
optionally adjusting the pH of the aqueous protein solution to a pH within a range varying from about 1.5 to about 2.5,
heating, with stirring, the solution obtained at a temperature ranging from about 35° C. to about 55° C., for a period of at least 10 hours.

A hydrogel preparation process is performed, for example, in the absence of water evaporation.

The hydrogel obtained comprises protein amyloid fibers.

Amyloid fiber wires (or amyloid wires) can be obtained by depositing and drying a given volume of hydrogel, comprising amyloid fibers, brought into contact with a tip of a first electrode and a tip of a second electrode, the first and second electrodes constituting an electrode pair. The drying of the hydrogel may be performed at room temperature in ambient atmosphere.

The electrode pair may be arranged on the surface of materials of varying nature and shape. The choice of the nature and shape of the materials intended to support the electrodes is adjusted by a person skilled in the art according to the use to be made of the electrodes. As materials that may be used, mention may be made of polymers or plastic resins, vitreous materials or fabrics.

On drying, the hydrogel drop comprising amyloid fibers will form a wire composed of amyloid fibers.

If required, the hydrogel drying can be performed with heating to accelerate the process. Alternatively, the hydrogel drying may be performed under reduced atmospheric pressure. Where appropriate, means of heating and obtaining reduced atmospheric pressure may be combined to dry the hydrogel and obtain amyloid protein fiber wires

When amyloid fibers or wires are used to generate electrical power, they may be impregnated with a buffer solution, such as an aqueous NaCl solution, for example 10 mM aqueous NaCl solution. Impregnation of the amyloid fibers or wires with such a solution advantageously allows the electrostatic repulsion between the amyloid fibers to be reduced, and reduces the risk of longitudinal cracks in the wire.

The volume of hydrogel to be used to prepare amyloid fiber wires may vary according to the dimensions of the wire or wires to be prepared, and the protein concentration.

The volume of hydrogel to be used may range from about 10 μL to about 50 μL, for example from about 15 μL to about 30 μL, and for example may be about 20 μL. The hydrogel volume to be used may be about 10 μL, or about 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or about 50 μL.

The amyloid fiber wires that may be obtained may range in length from about 0.5 to about 2.5 mm, for example from about 1.0 to about 2.0 mm, or even to about 1.5 mm. The amyloid fiber wires may be about 0.5 mm long, or about 0.6, 0.7, 0.8, 0.9, 1.0, 1.1, 1.2, 1.3, 1.4, or about 1.5 mm long.

The amyloid fiber wires that may be obtained may have a diameter ranging from about 300 μm to about 700 μm, for example from about 400 μm to about 600 μm, or even be about 500 μm. The amyloid fiber wires may have a diameter of about 300 um, or about 350, 400, 450, 500, 550, 600, 650 or about 700 μm.

For example, wires of α-lactalbumin amyloid fibers may be made from a hydrogel obtained as described herein and comprising about 40 g/L of protein. A volume of about 15 to about 20 μL, for example about 17 μL, of hydrogel may be deposited between the tips of a first and a second electrode of an electrode pair. Such a volume may afford wires measuring from about 1.0 to about 1.5 mm in length and about 500 μm in diameter.

As detailed in the examples hereinbelow, amyloid fibers and wires are capable of generating electrical power when placed in a humid surrounding atmosphere.

The amyloid fibers that are the subject of the present description are capable of generating ionic and protonic-type charges: the hydronium ion (HO₃⁺ or even H⁺_{aq}) from moisture in the surrounding atmosphere, and circulating them. Without wishing to be bound by any theory, it is proposed that the ions may enter the fibers either via their end terminations or their lateral faces and be guided along the fiber axis. It is also proposed that protons may move in the water channels of the amyloid fibers. When the channels are filled, the protons may move by jumping, step by step in a network of hydrogen bonds, via the Grothuss mechanism.

Due to the protonic nature of the charge transport, amyloid fiber conduction depends on the ambient humidity and thus on the filling the channels with water.

According to one embodiment, the amyloid fibers or wires described herein are exposed to (placed in contact with), at least in part, a humid surrounding atmosphere, i.e. one containing sufficient amounts of water vapor, to generate electrical power.

A humid surrounding atmosphere may comprise a relative humidity content from at least 10% to at least 95%, for example from at least about 20% to at least 80%, or even from at least 30% to at least 70%, or even from at least 40% to at least 60%. The relative humidity of an atmosphere may be measured by any known method, for example using a hygrometer.

When the humidity of the surrounding atmosphere varies, the intensity of the electrical power generated by the amyloid fibers or wires varies accordingly. This property may be capable of being used, for example, in moisture sensors or moisture-reactive electrical circuit breakers.

### Device Comprising Amyloid Fibers or Wires

According to one embodiment, in order to be able to capture and use the electrical power generated by the amyloid fibers or wires, the latter can be electrically connected to electrodes.

An amyloid fiber or wire may be electrically connected to a first and a second electrode. The first electrode is electrically connected, for example via a tip of this electrode, to a first point on the fiber or wire, and the second electrode is electrically connected, for example via a tip of this electrode, to a second point on the fiber or wire. The first and second electrodes may form an electrode pair.

According to one embodiment, the present disclosure relates to an electrical power generation device comprising:
a) at least one hydronium ion-conducting amyloid fiber, or at least one wire comprising a plurality of hydronium ion-conducting amyloid fibers,
b) at least one electrode pair comprising a first electrode and a second electrode, said electrodes being electrically connected to said fiber or wire,
said fiber or wire being intended (or configured) to be exposed, at least in part, to a humid surrounding atmosphere.

The first and second electrodes may be partially coated with a hydrophobic material. The hydrophobic material may be in contact with the amyloid fibers or the wire of amyloid fibers. The amyloid fibers or the wire of amyloid fibers are in direct contact with the material constituting the electrode.

A device as described herein may be manufactured via a process comprising at least the step of drying a hydrogel of amyloid fibers placed in contact with a first and a second electrode of an electrode pair to obtain an amyloid fiber wire electrically connected to said electrodes.

A device as described herein may be prepared via a process comprising at least the steps consisting in:
contacting a hydrogel of amyloid fibers with a first and a second electrode of an electrode pair to electrically connect said electrodes with the hydrogel, and
drying the hydrogel of amyloid fibers to obtain an amyloid fiber wire electrically connected to said electrodes.

A device as described herein may be prepared via a process comprising at least the steps consisting in:
preparing a hydrogel of amyloid fibers by dissolving proteins that are capable of self-assembling into amyloid fibers, in a content ranging from at least 5 g/L to the solubility limit, in an acidic saline solution with a pH ranging from about 1.5 to about 2.5, and then heating the solution obtained at a temperature ranging from about 35 to 55° C., for a period of at least 10 hours,
contacting the hydrogel of amyloid fibers prepared in step a) with a first and a second electrode of an electrode pair to electrically connect said electrodes with the hydrogel, and
drying the hydrogel to obtain an amyloid fiber wire electrically connected to said electrodes.

As indicated previously, a specific volume of hydrogel of amyloid fibers is placed between two tips between a first and a second electrode, so that the hydrogel is in contact with the electrodes. It is thus possible to ensure that the amyloid wire obtained after drying of the hydrogel is electrically connected to the electrodes.

The electrodes are arranged so that they are each capable of making contact with a point on the wire. A first electrode is in contact with a first point on the wire, and a second electrode is in contact with a second point on the wire.

An amyloid wire or fiber comprises a first end and a second end. According to one embodiment, a first electrode may be electrically connected, for example by a tip, to a first end of the wire or fiber, and a second electrode may be electrically connected, for example by a tip, to a second end of said wire or fiber.

Prior to depositing a drop of hydrogel of amyloid fibers between two electrodes of an electrode pair, a portion of the electrode intended to be in contact with the hydrogel drop may be coated with a hydrophobic and impermeable material intended to hold the hydrogel drop in place during its deposition and drying.

A suitable hydrophobic and impermeable material may be a wax or a gum. A wax may be an animal wax, a plant wax or even a synthetic wax such as paraffin. A wax may be beeswax. A gum may be gum arabic.

The hydrophobic material may be applied to the electrode surface by any method known in the field, for example by deposition or dipping the electrode in a bath of hydrophobic material, and then drying, for example at room temperature or by heating.

The hydrophobic material is applied to the electrode surface so as to allow the hydrogel drop to be in contact with the electrode and the hydrophobic material.

After deposition, the hydrogel drop is in contact with the electrode and the hydrophobic material. Contact between the drop and the material allows the drop to be stabilized in its position between the first and second electrodes during its drying.

After drying the drop of hydrogel of amyloid fibers, the amyloid wire obtained is stably attached to the first and second electrodes. The hydrophobic material may be removed or retained on the electrode.

The first and/or second electrodes may be chosen from gold, silver, platinum, aluminum or carbon, copper, iron, steel, bronze or mercury electrodes.

For example, the first and/or second electrodes may be chosen from gold, silver, platinum, aluminum or carbon electrodes.

The intensity of the electrical power generated by a device as described herein may depend on the moisture content of the surrounding atmosphere in contact with the amyloid fiber or wire. Also, the intensity may depend on the number of fibers or wires present in a device.

According to one embodiment, a device as described may comprise a plurality of wires, each electrically connected to a first and a second electrode.

According to one embodiment, a device may comprise a plurality of amyloid wires arranged in parallel.

According to another embodiment, a device may comprise a plurality of amyloid wires arranged in series.

According to an embodiment variant, a device as described herein may comprise a plurality of pairs of first and second electrodes, each of said electrode pairs being electrically connected to one wire or a plurality, at least 2, 3, 4, 5, 6, 7, 8, 9, 10, 20, 30, 40, 50, 60, 70, 80, 90, 100, 200, 500, 1000, or more, of wires. In such an embodiment, the wires are thus electrically connected in parallel.

A device as described herein may comprise a plurality of pairs of first and second electrodes. These electrode pairs may be electrically connected to each other in series or in parallel.

According to an implementation variant, a device as described herein may comprise a pair of first and second electrodes, or a plurality, at least 2, 3, 4, 5, 6, 7, 8, 9, 10, 20, 30, 40, 50, 60, 70, 80, 90, 100, 200, 500, 1000, or more, pairs of first and second electrodes, each pair of first and second electrodes being electrically connected to a wire, or a plurality of wires, at least 2, 3, 4, 5, 6, 7, 8, 9, 10, 20, 30, 40, 50, 60, 70, 80, 90, 100, 200, 500, 1000, or more, as described herein. Where at least two, or more, electrode pairs are present, these may be electrically connected to each other in series or in parallel.

A parallel architecture advantageously enables the internal resistance to be reduced.

A series architecture advantageously allows the circuit's charge potential to be increased to several volts. A series architecture also affords a high internal resistance, and enables the custom design and production of a device with a well-defined final resistance.

According to one embodiment, a device may comprise a plurality of amyloid wires arranged in parallel and a plurality of amyloid wires arranged in series.

According to one embodiment, a device may comprise a plurality of electrode pairs electrically connected to one or a plurality of amyloid wires and arranged in parallel, and a plurality of electrode pairs electrically connected to one or a plurality of amyloid wires and arranged in series.

The plurality of wires or electrode pairs may be arranged to form a planar two-dimensional configuration, or a three-dimensional configuration.

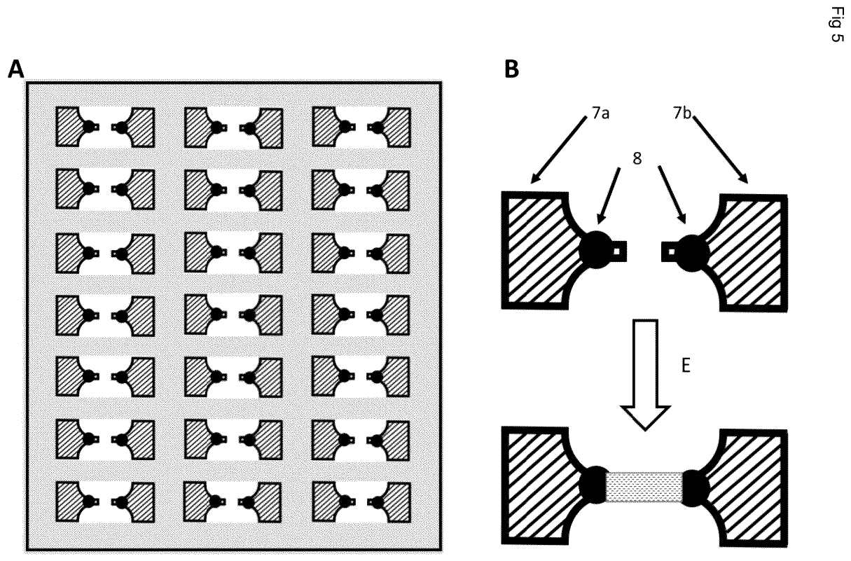

According to one embodiment, illustrated in FIG. 5, a plurality of electrode pairs may be arranged on a support, for example by 3D printing or lithography. Prior to depositing a drop of hydrogel of amyloid fibers between the first and second electrodes of each electrode pair, a portion of the surface of each electrode may be coated with a hydrophobic material, for example a wax. A drop of hydrogel can then be deposited between the first and second electrodes of each electrode pair. The electrode pairs can then be connected to each other in series and/or parallel.

According to one embodiment, a device comprises at least one amyloid fiber or at least one amyloid wire arranged in such a way that at least 50%, for example at least 60%, at least 70%, at least 80%, at least 90% or even 100% of the length of the fiber or wire is exposed to the humid surrounding atmosphere.

A device as described herein may be an electrical power supply device, for example a battery.

### Uses of the amyloid fibers and wires

The amyloid fibers or wires described herein, and also the devices described herein, may be used in a humid surrounding atmosphere to generate electrical power. The electrical power thus obtained may be intended for powering various items of electrical or electronic apparatus.

A device as described herein may be used to supply electrical power to an electrical or electronic apparatus intended to be supplied with electrical power.

A process is described herein for supplying electrical power to an electrical or electronic apparatus intended, or configured, to be supplied with electrical power. Such a process may comprise at least one step consisting in exposing to a humid surrounding atmosphere, at least partially, at least one hydronium ion-conducting amyloid fiber, or at least one wire of such fibers, said fiber or wire being arranged in an electrical power generating device as described herein, said device being electrically connected to said electrical or electronic apparatus.

According to another embodiment, the present disclosure relates to a process for supplying electrical power to an electrical or electronic apparatus intended to be supplied with electrical power, the process comprising at least the steps consisting in:
a) electrically connecting a device as described to an electrical or electronic apparatus intended to be fed with electrical power, and
b) exposing, at least partially, said fiber or said wire to a humid surrounding atmosphere.

A device described herein may advantageously be used in a high-humidity area, for example a marine environment, for recharging small items of electrical or electronic apparatus, such as smartphones, sensors, for example humidity sensors, beacons, electrical chargers, or lamps.

According to one embodiment, the present disclosure relates to a moisture sensor, a moisture-reactive electrical circuit breaker, or an electrical charger comprising at least one device as described herein.

The terms “about” or “approximately” mean an acceptable measurement error for a particular value of a parameter determined by measurement methods customary in the field and which will partly depend on how the value is measured or determined, i.e. on the limits of the measurement system. For example, the term “about” may mean within a range of three or more than three standard deviations, according to the practice of the art. Alternatively, the term “about” may mean a range of up to 20%, for example up to 10%, for example up to 5%, and even up to 1% of a given value.

The term “comprise” is to be interpreted as specifying the presence of the indicated features, integers, steps or components, but not excluding the presence of one or more other features, integers, steps or components, or a group thereof. It may also strictly specify the features, integers, steps or components indicated and, in this case, may be replaced with “consists of”.

The list of sources and components described herein is enumerated such that combinations and mixtures thereof are also contemplated and are within the scope of the present disclosure.

It should be understood that each indicated maximum numerical limit includes each lower numerical limit, as if these lower numerical limits were expressly mentioned. Each indicated minimum numerical limit comprises each upper numerical limit, as if these upper numerical limits were expressly mentioned. Each numerical range comprises each narrower numerical range that lies within a wider numerical range, as if these narrower numerical ranges were all expressly written.

All the lists of items are intended to be and must be interpreted as Markush groups. Thus, all the lists may be read and interpreted as items “selected from the group consisting of . . . items . . . , and combinations and mixtures thereof”.

The inventors do not intend to be limited by materials under a particular trade name. Materials equivalent to those referenced by a trade name may be substituted and used in the descriptions herein.

It is understood that the present description encompasses all variations, combinations and permutations in which at least one limitation, element, clause, descriptive term, etc., of at least one of the claims is introduced into another dependent claim of the same basic claim (or, where appropriate, into any other claim), unless otherwise indicated or unless it is obvious to a person skilled in the art that a contradiction or inconsistency would arise. Where elements are presented in the form of lists, for example in a Markush group or the like, it is to be understood that each sub-group of elements is equally disclosed and that any element may be removed from the group. It is to be understood that, in general, where the disclosure, or aspects of the disclosure, is/are denoted as comprising particular elements, features, etc., it/they also encompass embodiments consisting of, or consisting essentially of, such elements, features, etc. For the sake of simplicity and brevity, these elements have not always been specifically set out herein. It should also be understood that any embodiment or aspect of the disclosure may be explicitly excluded from the claims, whether or not the specific exclusion is mentioned in the description. Publications and other reference documents mentioned in the description to describe the context of the invention and to provide further details concerning its implementation are incorporated by reference.

Without limiting the present description of the invention, various embodiments of the invention are described hereinbelow for illustrative purposes.

### EXAMPLES

### Example 1: Preparation of a Hydrogel of Amyloid Fibers

A hydrogel of amyloid fibers is prepared as described in Example 1 of patent application FR 2 973 648 A1 or Example 2 of WO 2012/136909.

The purified protein, α-lactalbumin: “α-Lactalbumin from bovine milk Type III, calcium depleted, >85%” (α-LAC) sold under catalog number “L6010” by Sigma, is freeze-dried and suspended in an aqueous HCl solution containing or not NaCl.

The HCl concentration depends on the final α-LAC concentration. It is calculated in mM by adding 10 to the numerical value of the desired α-LAC concentration. For example, if the desired α-LAC concentration is 40 mg/mL, the HCl concentration for suspension purposes will be 40+10=50 mM.

First, the HCl solution must be prepared to the required concentration, and NaCl is then added at between 0 and 60 mM. In the hydrogels used to obtain the amyloid wires used in the examples, a 10 mM HCl concentration was used. The next step is to weigh out the amount of α-LAC required. This amount depends on the final protein concentration and the gel volume to be prepared. The α-LAC concentrations used range from 5 g/L to the solubility limit. In the hydrogels used to obtain the amyloid wires used in the examples, an α-LAC concentration of 40 g/L was used.

The protein is dissolved in the defined volume of HCl solution and the pH is then adjusted to 2.0±0.1 with a few microliters of 1M HCl. The solution is placed under magnetic stirring using a magnetic bar and incubated overnight at a temperature of about 45° C. The next day, about 16 hours later, the gel is formed.

### Example 2: Preparation of the Energy Recovery Device

In order to recover electrical power from ambient humidity, α-LAC wires are produced between the ends of two platinum wires.

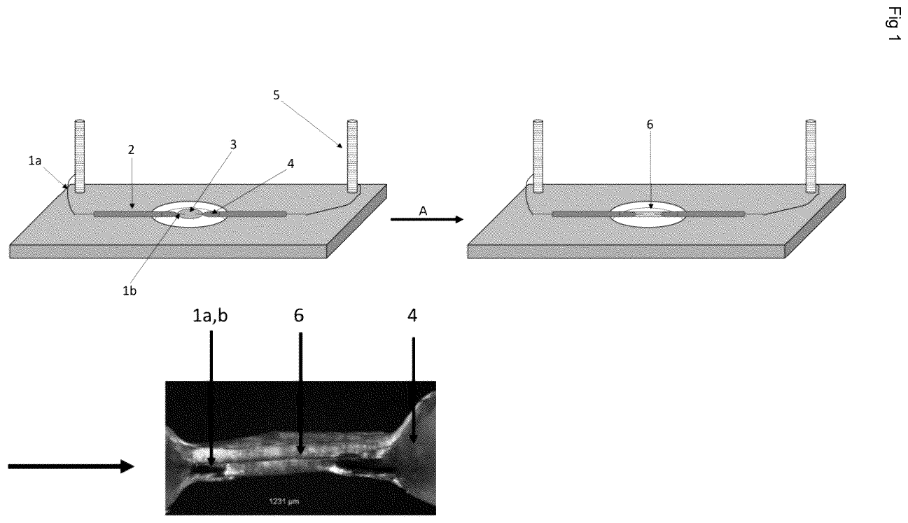

To do this, 17 μL of hydrogel solution are deposited between the ends of two platinum wires (Thermo Fischer (ALFA AESAR): 0263). These two platinum wires are inserted into a glass capillary (VWR (microcaps): DRUM1-000-0090) and the whole assembly is dipped in beeswax so as to allow a drop to be held between the tips. The platinum wire is trimmed and cut so that there is no wax residue on the wires. The drop is then left to dry at room temperature and humidity for a few hours, for example between 1 and 3 hours (FIG. 1).

After deposition, the drop of hydrogel of amyloid fibers is in contact with the wax. Contact with the wax allows the hydrogel drop to be stabilized and held between the electrode tips during drying. After deposition, the hydrogel drop is in contact with the platinum electrodes and the wax.

While the hydrogel drop of the amyloid wires is drying, due to electrostatic repulsion between the fibers, they may split lengthwise. In order to obtain stronger wires and reduce the risk of longitudinal splitting, the amyloid wires are impregnated with 10 mM NaCl solution.

The device is fed with humidity by placing it in a ClimaCell 11 climatic chamber, controlled by the Warmcomm software.

### Example 3: Electronic Characterization of the α-LAC Wires

Electronic characterization of the α-LAC wires was performed using a Biologic SP-200 potentiostat and its low-current probe. Humidity control was performed using a ClimaCell 11 climatic chamber, controlled by Warmcomm software.

Due to the chemical nature of the amyloid fibers, the charge they carry is of ionic and protonic type, the hydronium ion (HO₃⁺ or even H⁺_{aq}) being a particular ion. The ions will enter the fibers either via their end terminals or their lateral faces, and thus be guided along their axis. Another mechanism is involved in the case of proton transfer. Specifically, the amyloid fibers have water channels. When the channels are filled, the protons move in jumps (step by step in a network of hydrogen bonds) via the Grothuss mechanism (Rongier, 2016).

Due to the protonic nature of the charge transport, the conduction of the amyloid fibers is intrinsically dependent on the ambient humidity and thus on the filling of the water channels. For these reasons, the possibility of the presence of a potential difference between the electrodes was investigated. The protein wires are placed in the climatic chamber at high humidity (95%) and the open-circuit potential difference between the two platinum wires was recorded.

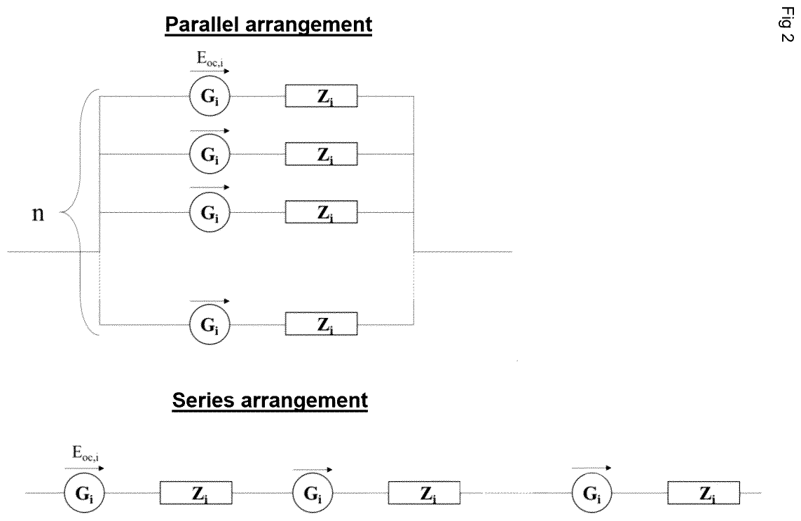

Three configurations were tested: single wire, three wires in parallel and three wires in series (FIG. 2). For the parallel and series circuits, features related to the potential and the internal resistance are mentioned in FIG. 2.

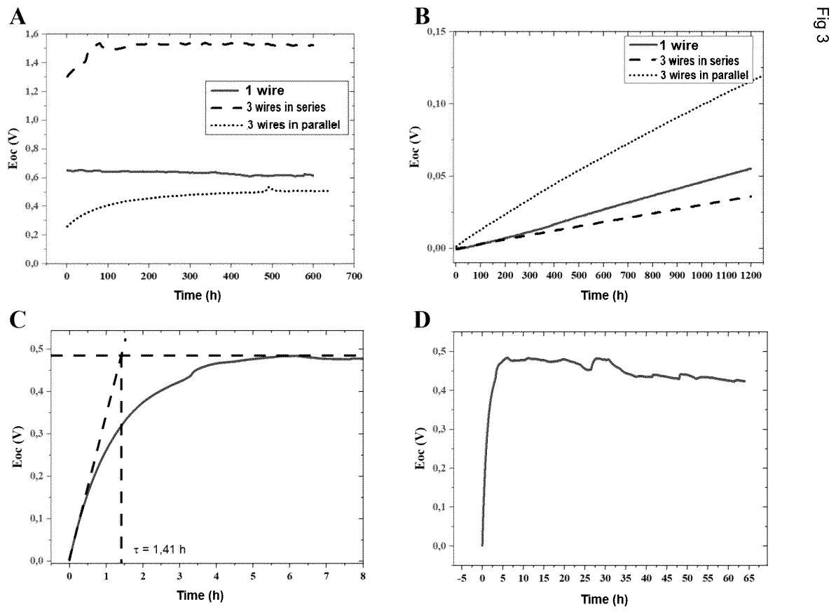

The open-circuit potential (E_{oc} (V)) was studied for these three different typical configurations (FIG. 2) at 95% relative humidity: a single wire alone, three wires connected in series and these same three wires connected in parallel (FIG. 3 (A)). The E_{oc} observed for the three wires tested (only one represented) are: 615 mV, 595 mV and 510 mV. When these wires are connected in series, an E_{oc} of 1.52 V is obtained (compared with 1.72 V theoretically achievable, i.e. the sum of the three E_{oc}). Finally, when these same three wires are connected in parallel, the E_{oc} is 550 mV, as expected for a parallel connection.

A capacitor with a capacitance of 470 μF and a voltage of 16 V was charged according to the three configurations described previously (FIG. 3 (B)). Between each test, the capacitor was discharged across a resistor until zero voltage was obtained. It can be seen that the capacitor's charge slopes range according to the circuit. These slopes are directly related to the internal resistance of the wires, as τ=RC (circuit time constant). Thus, when there are three wires in series, charging is slower since the internal resistances add up. Thus the best possible configuration is obtained for wires arranged in parallel, since in this case the internal resistance decreases. The capacitor was thus charged with all three wires in parallel, so as to determine its charging time (FIG. 3(C)). The capacitor thus reached a limit voltage of 490 mV after 5.5 h. This value is lower than the theoretical value (550 mV) of the E_{oc} of the three wires in parallel. This may be due to the loss of stability of the E_{oc} of the wires over time. When the time constant t of the capacitor charge is determined, a value of 1.41 h is obtained. Considering that a capacitor is charged after 4 τ, a value of 5.5 h is indeed obtained.

The internal resistance of the wires arranged in parallel can also be determined, which is 11.6 MΩ (megaohms). The capacitor was then charged for 50 h (FIG. 3 (D)). Fluctuations in the capacitor potential may be noted. These fluctuations may be due to the α-lactalbumin wires, whose potential may range over time. At the end of the experiment, an E_{oc} of 420 mV may be observed. The E_{oc} of the three wires in parallel was measured at the end of the experiment: it is 420 mV. This thus confirms that charge fluctuations are linked to the E_{oc} of the wires.

### Example 4: Influence of Relative Humidity on Eoc

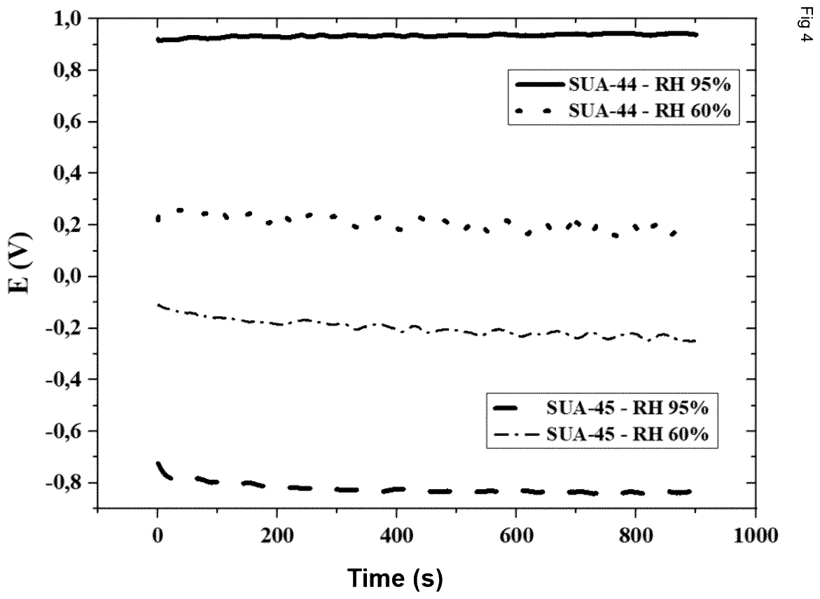

The influence of relative humidity on the E_{oc} of two wires was also tested (FIG. 4). The two wires were first tested at 95% and the Climacell's relative humidity (RH) was then lowered to 60%. It can be seen that when the relative humidity is reduced, the E_{oc} decreases by a factor of 4, but remains stable over time (15 min). It will also be noted that when the connections across the platinum wires are reversed, the potential difference becomes negative, indicating that the α-lactalbumin wires are naturally polarized in the presence of water vapor.

The results obtained in Examples 2 to 4 demonstrate proof of concept that amyloid fiber wires are capable of recharging a capacitor with ambient humidity alone.

### LIST OF CITED DOCUMENTS

Jackson M. P., Hewitt E. W. Why are Functional Amyloids Non-Toxic in Humans? Biomolecules. 2017; 7(4):71. Published 2017 Sep. 22. doi: 10.3390/biom7040071.
Lee, S., Choi, M.C., Al Adem, K. et al. Aggregation and Cellular Toxicity of Pathogenic or Non-pathogenic Proteins. Sci. Rep. 10, 5120 (2020). https://doi.org/10.1038/s41598-020-62062-3.
Liu, X., Gao, H., Ward, J. E. et al. Power generation from ambient humidity using protein nanowires. Nature 578, 550-554 (2020). https://doi.org/10.1038/s41586-020-2010-9.
Roberts R. G. (2016) Good Amyloid, Bad Amyloid-What's the Difference? PLoS Biol. 14(1):e1002362. https://doi.org/10.1371/journal.pbio.1002362.
Roma N. Rambaran and Louise C. Serpell (2008), Amyloid fibrils review, Prion, Vol. 2 issue 3.
Rongier A. (2016) Thesis: “Auto-assemblage de protéines pour 1a bioéléctronique: Etude du transport de charges dans les fibres amyloïdes [Protein self-assembly for bioelectronics: Study of charge transport in amyloid fibers]” Université Grenoble Alpes.
Stephens, G., Li, J., Wild, M. et al. An update on Earth's energy balance in light of the latest global observations. Nature Geosci. 5, 691-696 (2012). https://doi.org/10.1038/ngeo1580.
Tang, Q., Duan, Y., He, B., and Chen, H. (2016). Platinum Alloy Tailored All-Weather Solar Cells for Energy Harvesting from Sun and Rain. Angew. Chem. Int. Ed. 55, 14412-14416.
WO 2012/136909-Thixotropic α-lactalbumin hydrogels, methods for preparing same and uses thereof.
Xu, W., Zheng, H., Liu, Y. et al. A droplet-based electricity generator with high instantaneous power density. Nature 578, 392-396 (2020). https://doi.org/10.1038/s415860201985-6.
Yang, S., Su, Y., Xu, Y., Wu, Q., Zhang, Y., Raschke, M. B., Ren, M., Chen, Y., Wang, J., Guo, W., et al. (2018). Mechanism of Electrical power Generation from Ionic Droplet Motion on Polymer Supported Graphene, J. Am. Chem. Soc. 140, 13746-13752.
Yin, J., Zhang, Z., Li, X., Yu, J., Zhou, J., Chen, Y., and Guo, W. (2014). Waving potential in graphene. Nat. Commun. 5, 3582.
Zhang, Z., Li, X., Yin, J. et al. Emerging hydrovoltaic technology. Nature Nanotech. 13, 1109-1119 (2018). https://doi.org/10.1038/s41565-018-0228-6.

1. A use of at least one hydronium ion-conducting amyloid fiber, or of at least one wire comprising a plurality of hydronium ion-conducting amyloid fibers, for generating electrical power from a humid surrounding atmosphere.

2. The use as claimed in claim 1, in which said fiber or wire is electrically connected to a first and a second electrode.

3. An electrical power generation device comprising:
a) at least one hydronium ion-conducting amyloid fiber, or at least one wire comprising a plurality of hydronium ion-conducting amyloid fibers,
b) at least one electrode pair comprising a first electrode and a second electrode, said electrodes being electrically connected to said fiber or wire, said fiber or wire being intended to be exposed, at least in part, to a humid surrounding atmosphere.

4. The device as claimed in claim 3, comprising a plurality of pairs of first and second electrodes, each of said electrode pairs being electrically connected to a wire or to a plurality of wires.

5. The device as claimed in claim 3, in which said fiber is composed of proteins chosen from α-lactalbumin, β-lactoglobulin, lysozyme, or a HET-s protein.

6. The device as claimed in claim 3, in which the first and/or second electrodes are chosen from gold, silver, platinum, aluminum or carbon electrodes.

7. The device as claimed in claim 3, for supplying electrical power to an electrical or electronic apparatus intended to be supplied with electrical power.

8. A process for supplying electrical power to an electrical or electronic apparatus intended to be supplied with electrical power, the process comprising at least one step consisting in exposing to a humid surrounding atmosphere, at least partially, at least one hydronium ion-conducting amyloid fiber, or at least one wire comprising a plurality of hydronium ion-conducting amyloid fibers, said fiber or said wire being arranged in a device for producing electrical power as claimed in claim 3, said device being electrically connected to said electrical apparatus.

9. A process for manufacturing a device as claimed in claim 3, comprising at least one step consisting of drying a hydrogel of amyloid fibers disposed between a first and a second electrode of an electrode pair to electrically connect said electrodes with the hydrogel to obtain an amyloid fiber wire electrically connected to said electrodes.

10. A moisture sensor, moisture-reactive circuit breaker, or electrical charger comprising at least one device as claimed in claim 3.
